(19) United States
(12) Patent Application Publication
(10) Pub. No.: US 2026/0011918 A1
(43) Pub. Date: Jan. 8, 2026

(54) COMPACT DUAL BAND ANTENNA

(71) Applicant: Honeywell International Inc., Charlotte, NC (US)

(72) Inventors: Zhong Liu, Doylestown, PA (US); Amit B. Kulkarni, Duluth, GA (US); Justin Jose, Muvattupuzha (IN)

(21) Appl. No.: 19/324,839

(22) Filed: Sep. 10, 2025

Related U.S. Application Data
(63) Continuation of application No. 18/160,065, filed on Jan. 26, 2023, now Pat. No. 12,431,621.

(51) Int. Cl. H01Q 5/307; H01Q 1/48; H01Q 9/04

(52) U.S. Cl. CPC H01Q 5/307; H01Q 1/48; H01Q 9/0407

(57) ABSTRACT

An antenna system formed by one or more layers of a Printed Circuit Board (PCB). The antenna system includes a first antenna element configured to resonate in a first frequency band centered at about 5.4 GHz and a second antenna element configured to resonate in a second frequency band centered at about 2.4 GHz. The first antenna element and the second antenna element fit within a rectangular area of less than about 100 square millimeters on the PCB. The first antenna element has a bandwidth of at least 2 GHz and the second antenna element has a bandwidth of at least 100 MHz, wherein the bandwidth is defined as having less than a −10 dB return loss within the band. The first antenna element and the second antenna element may be formed on a common conductive layer of a PCB.

### CROSS-REFERENCE TO RELATED APPLICATIONS

This application is a continuation of U.S. application Ser. No. 18/160,065, filed Jan. 26, 2023, which is incorporated by reference herein in its entirety.

### TECHNICAL FIELD

The present disclosure pertains to antennas that may be used in a variety of wireless applications and more particularly pertains to dual band antennas having a small physical footprint.

### BACKGROUND

A variety of electronic devices utilize antennas for wirelessly transmitting and/or receiving information. In some cases, it may be desirable for an electronic device to have the capability of communicating over two or more different frequency bands. What would be desirable is a dual band antenna that can be easily and inexpensively incorporated into a variety of different electronic devices to support communication over each of two different frequency bands.

### SUMMARY

This disclosure pertains to antennas that may be used in a variety of wireless applications and more particularly pertains to dual band antennas having a small physical footprint. An example may be found in a dual band antenna that includes a ground plane formed by a first conductive layer of a Printed Circuit Board (PCB). In this example, a first antenna element is formed by the first conductive layer of the PCB, where the first antenna element is spaced from and electrically isolated from the ground plane. The first antenna element is configured to resonate in a first frequency band. A second antenna element is also formed by the first conductive layer of the PCB. The second antenna element is electrically connected to the ground plane and electromagnetically coupled to the first antenna element. The second antenna element is configured to resonate in a second frequency band. The first antenna element and the second antenna element are configured to fit within a rectangular area of less than about 100 square millimeters on the PCB.

Another example may be found in an antenna system. In this example, the antenna system includes a first antenna that is configured to resonate in a first frequency band and a second antenna that is configured to resonate in a second frequency band. The first antenna includes a base element having a major dimension of less than about 5 millimeters, and a cross clement extending at least substantially orthogonally to the base element. The cross element is electrically connected with the base element and has a major dimension of less than about 10 millimeters. The base element is operatively coupled to a signal trace that is operatively coupled to an antenna driver and/or receiver. The example antenna system also includes a second antenna that is spaced from the first antenna and is configured to resonate in a second frequency band. The second antenna is electromagnetically coupled to the first antenna. The second antenna includes a first member extending at least substantially parallel with the base element of the first antenna and alongside a first end of the cross element of the first antenna. In this example, the first member has a major dimension of less than about 10 millimeters and is electrically connected to a ground plane. The second antenna further includes a second member that is electrically connected with the first member and extending along the cross element of the first antenna and at least substantially parallel with the major dimension of the cross element of the first antenna. The second member has a major dimension of less than about 15 millimeters. The second antenna further includes a third member that is electrically connected with the second member and extending at least substantially parallel with the first member of the first antenna and alongside a second end of the cross element opposite the first end. The third member has a major dimension that is less than the major dimension of the first member of the second antenna.

Another example may be found in an antenna system that is formed by one or more layers of a Printed Circuit Board (PCB). The antenna system includes a first antenna element configured to resonate in a first frequency band centered at about 5.4 GHz and a second antenna clement configured to resonate in a second frequency band centered at about 2.4 GHz. The first antenna element and the second antenna element may be electromagnetically coupled to one another and may fit within a rectangular area of less than about 100 square millimeters on the PCB. The first antenna element has a bandwidth of at least 2 GHz and the second antenna element has a bandwidth of at least 100 MHz, wherein the bandwidth is defined as having less than a −10 dB return loss within the band. In some cases, the first antenna element and the second antenna element, along with a ground plane, are patterned from a common conductive layer of the PCB, thereby forming a single conductive layer dual band antenna that has a small footprint and wide upper and lower frequency bands.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic diagram showing an illustrative dual band antenna;

FIG. 2 is a cross-sectional view taken along line 2-2 of FIG. 1;

FIG. 3 is a schematic diagram of the illustrative dual band antenna of FIG. 1, with various dimensions denoted;

FIG. 4 is a schematic diagram of the illustrative dual band antenna of FIG. 1, with its physical footprint denoted;

FIG. 5 is a graphical representation of simulated antenna return loss for the dual band antenna shown in FIG. 2, with the magnitude expressed in decibels (dB);

FIG. 6 is a graphical representation of simulated antenna efficiency for the dual band antenna of FIG. 5, with the magnitude expressed in decibels (dB); and

FIG. 7 is a graphical representation of simulated antenna efficiency for the dual band antenna of FIG. 5, with the magnitude expressed as a percentage.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The term “about” means within a range of plus or minus 10 percent of the expressed number. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

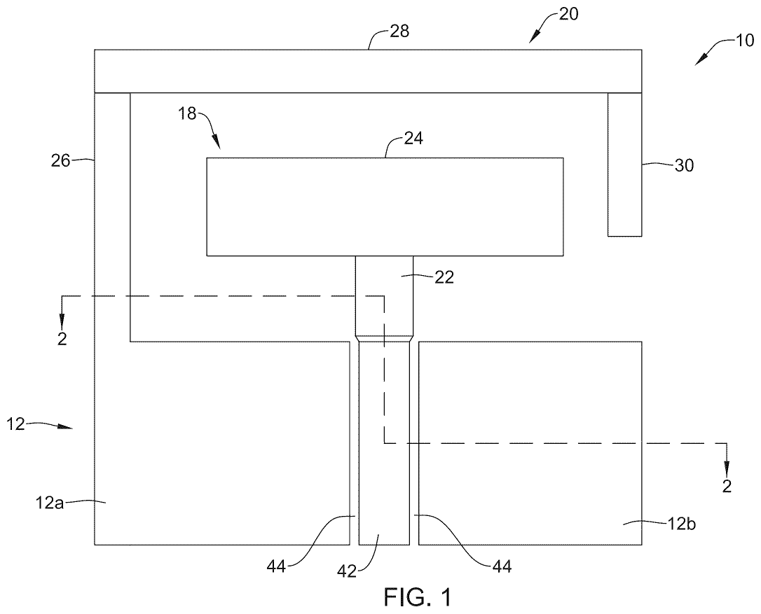

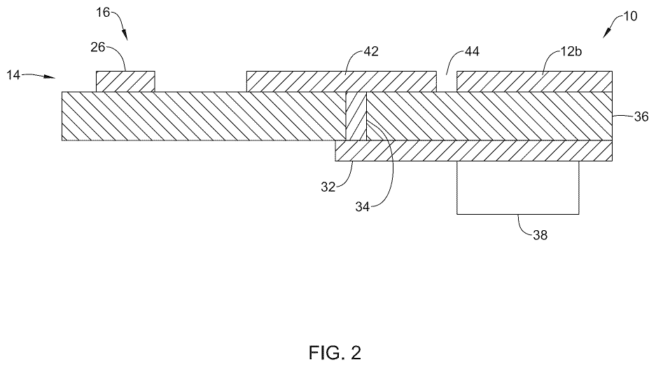

FIG. 1 is a schematic diagram of an illustrative dual band antenna 10 and FIG. 2 is a cross-sectional view of the dual band antenna 10, taken along the line 2-2 of FIG. 1. The dual band antenna 10 includes a ground plane 12 that, as seen in FIG. 2, is formed by a first conductive layer 14 of a Printed Circuit Board (PCB) 16. In this example, a first antenna element 18 is also formed by the first conductive layer 14 of the PCB 16, and is laterally spaced from and electrically isolated from the ground plane 12 as shown in FIG. 1. The first antenna element 18 may be electrically coupled to a signal 23 that is driven and/or received by an antenna driver and/or receiver component.

In some instances, the first antenna element 18 may be configured to resonate in a first frequency band with a bandwidth of at least 2 GHz. As an example, the first frequency band may be centered at about 5.4 GHz. A second antenna element 20 is also formed by the first conductive layer 14 of the PCB 16. The second antenna element 20 is electrically connected to the ground plane 12 and is configured to be electrically isolated from but electromagnetically coupled to the first antenna element 18. In some instances, the second antenna element 20 may have a bandwidth of at least 100 MHz and may be considered as being configured to resonate in a second frequency band. As an example, the second frequency band may be centered at about 2.4 GHz. In some cases, the “bandwidth” of the first frequency band and the “bandwidth” of the second frequency band may be defined as having less than a −10 dB return loss within the band.

In some cases, a first frequency band that is centered at about 5.4 GHz may refer to a frequency band that is centered at 5.4 GHz±20 percent, or 5.4 GHz±10 percent. The first frequency band may range from about 5.15 GHz to about 5.85 GHz. A second frequency band that is centered at about 2.4 GHz may refer to a frequency band that is centered at 2.4 GHz±20 percent, or 2.4 GHz±10 percent. In some cases, the first frequency band may be suitable for WiFi communication, and the second frequency band may be suitable for WiFi and/or Bluetooth communication.

In some instances, as shown in FIG. 1, the first antenna element 18 may be considered as being T-shaped, with a first member 22 forming a vertical (in the illustrated orientation) portion of the T and a second member 24 that is orthogonal to the vertical portion (the first member 22). In some cases, the second antenna element 20 may be spaced from and may extend along at least part of at least three sides of the second member 24 of the first antenna element 18. In some instances, the second antenna element 20 includes a third member 26 that extends at least substantially parallel with the first member 22 of the first antenna element 18, a fourth member 28 that is connected with the third member 26 and extends at least substantially parallel with the second member 24 of the first antenna element 18, and a fifth member 30 that is connected with the fourth member 28 and extends at least substantially parallel with the third member 26.

As seen in FIG. 1, the ground plane 12 may be considered as being divided into a first ground plane 12a and a second ground plane 12b. In some cases, a conductive element 42 is electrically isolated from the first ground plane 12a and the second ground plane 12b via etched areas 44. The conductive layer 42 may be electrically coupled with the first member 22 of the first antenna element 18.

With particular attention to FIG. 2, the illustrative PCB 16 may include a second conductive layer 32 that is patterned on a second side of the PCB 16 opposite that of the first conductive layer 14. In some cases, the second conductive layer 32 may be electrically coupled with the conductive element 42, and hence with the first antenna element 18, by an electrically conductive via 34 that passes through an insulative layer 36 of the PCB 16. In some cases, the insulative layer 36 of the PCB 16 may have a thickness of 1.6 millimeters, and may be formed of, or otherwise include, FR4. FR4 is a fiberglass-reinforced epoxy laminate material, and is considered to be flame-retardant. FR-4 glass epoxy has a good strength to weight ratio.

In some cases, an electrical device 38 may be coupled to the second conductive layer 32. In some instances, the electrical device 38 may be a transmitter and/or a receiver, and may include an electrical contact that is electrically coupled to the second conductive layer 32, and thus electrically connected to the first antenna element 18 via the conductive element 42 and the conductive via 34. In some cases, the electrical device 38 may include an impedance matching circuitry, filtering circuitry (e.g. bandpass filtering) and/or amplification circuitry, for example.

In some instances, a portion of the second conductive layer 32, including the conductive element 42 and the conductive via 34, may be considered as having an impedance that matches that of the dual band antenna 10. This may help prevent signal reflections at the interface, thereby improving the effective antenna efficiency. As an example, the conductive path between the electrical device 38 and a contact point of the dual band antenna 10 may represent a transmission line (e.g. co-planer microstrip line) that has an impedance of about 50 ohms, and the dual band antenna 10 may represent an impedance of about 50 ohms.

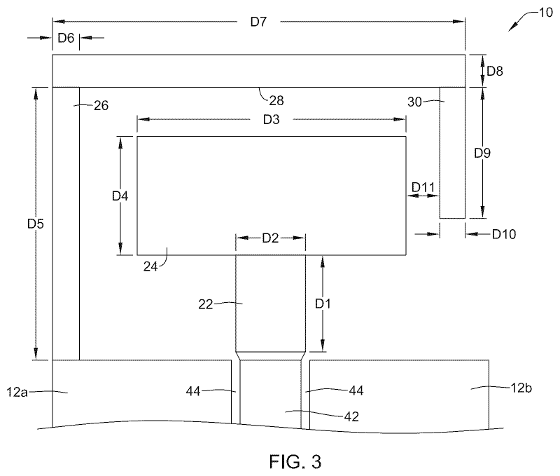

FIG. 3 is similar to FIG. 1, but labels a number of dimensions of the dual band antenna 10. With respect to the first antenna element 18, the first member 22 may be considered as being a base element while the second member 24 may be considered as being a cross element that extends at least substantially orthogonally to the base element. The first member 22 may be considered as having a major dimension DI that is less than about 5 millimeters and a minor dimension D2 that is less than about 2 millimeters. The second member 24 may have a major dimension D3 that is less than about 10 millimeters and a minor dimension D4 that is less than about 4 millimeters.

With respect to the second antenna element 20, the third member 26 has a major dimension D5 of less than about 10 millimeters and a minor dimension D6 of less than 1 millimeter. The fourth member 28 has a major dimension D7 of less than about 15 millimeters and a minor dimension D8 of less than about 1.5 millimeters. The fifth member 30 has a major dimension D9 of less than D5 and a minor dimension D10 of less than 1.5 millimeters. In some cases, D9 may be about half of D5. In some cases, a spacing D11 between the second member 24 of the first antenna element 18 and the fifth member 30 of the second member 24 may influence the electromagnetic coupling between the first antenna element 18 and the second antenna element 20.

In a particular example, D1 is equal to 2.97 millimeters and D2 is equal to 1.5 millimeters, D3 is equal to 7.1 millimeters and D4 is equal to 2.1 millimeters, D5 is equal to 7.3 millimeters and D6 is 0.5 millimeters, D7 is 9.8 millimeters and D8 is 0.8 millimeters, D9 is 2.4 millimeters and D10 is 0.8 millimeters. In a particular example, D11 may be 0.55 millimeters. Other dimensions are also contemplated.

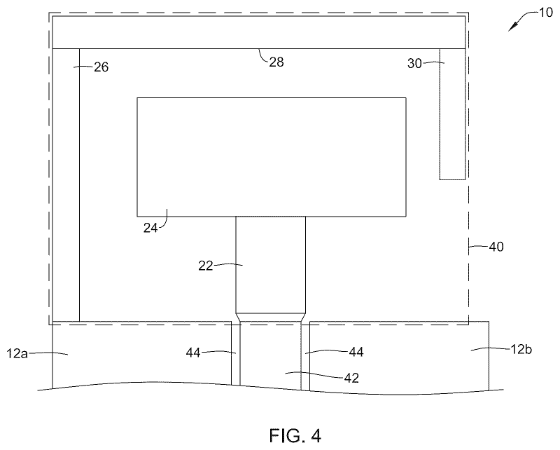

FIG. 4 is a schematic diagram of the illustrative dual band antenna 10 in which a physical footprint indicator 40 is shown in phantom around the dual band antenna 10. The physical footprint indicator 40 is intended to define what is considered to be the physical footprint or area of the dual band antenna 10. The physical footprint of the dual band antenna 10, as indicated by the physical footprint indicator 40, may be considered as being rectilinear, with a major dimension and a minor dimension that is orthogonal to the major dimension.

In some cases, a major dimension of the physical footprint, as indicated by the physical footprint indicator 40, may be less than about 15 millimeters. In some cases, the physical footprint may have a major dimension of less than about 10 millimeters and a minor dimension (orthogonal to the major dimension) that is less than about 8 millimeters.

In some instances, the dual band antenna 10 has a physical footprint, as indicated by the physical footprint indicator 40, of less than 200 square millimeters. In some instances, the dual band antenna 10 has a physical footprint, as indicated by the physical footprint indicator 40, of less than 100 square millimeters. In some instances, the dual band antenna 10 has a physical footprint, as indicated by the physical footprint indicator 40, of less than 75 square millimeters.

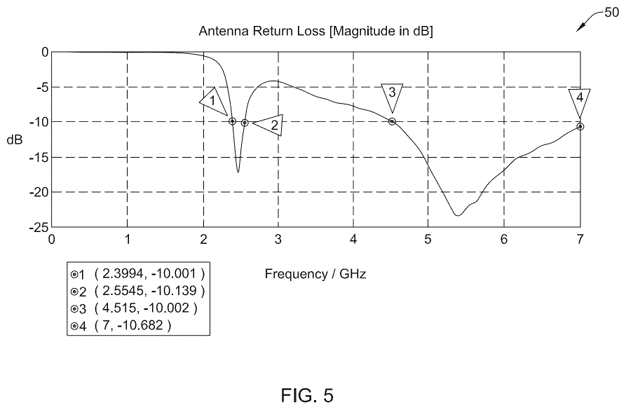

FIG. 5 is a graphical representation 50 of simulated antenna return loss data for the dual band antenna shown in FIG. 2. In this particular example, D1 is equal to 2.97 millimeters and D2 is equal to 1.5 millimeters, D3 is equal to 7.1 millimeters and D4 is equal to 2.1 millimeters, D5 is equal to 7.3 millimeters and D6 is 0.5 millimeters, D7 is 9.8 millimeters and D8 is 0.8 millimeters, D9 is 2.4 millimeters, D10 is 0.8 millimeters and D11 is 0.55 millimeters. Also, in this example, the first antenna element 18, the second antenna element 20 and the ground plane 12 are all formed on a common conductive layer patterned on an FR4 PCB layer that has a thickness of 1.6 mm. It can be seen that there is a significant reduction in return loss at about 2.4 GHz and another significant reduction in return loss at about 5.4 GHz.

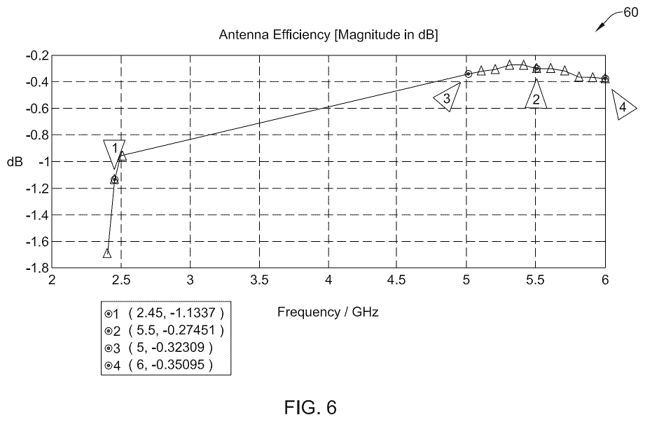

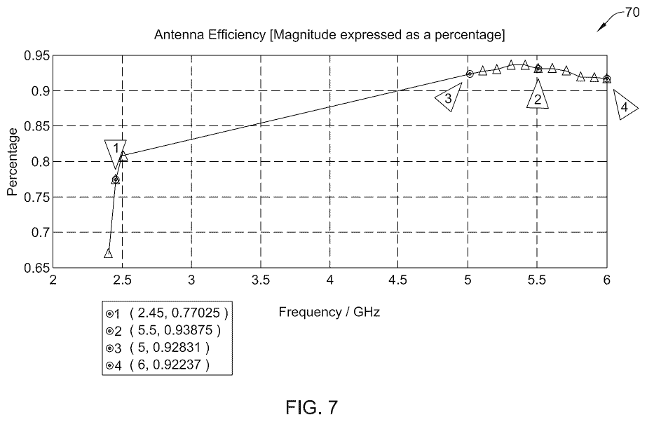

FIG. 6 is a graphical representation 60 of simulated antenna efficiency for the dual band antenna of FIG. 5, with the magnitude expressed in decibels (dB). It can be seen that there is a sharp increase in total efficiency around 2.4 GHz and a local maximum in total efficiency around 5.4 GHz. FIG. 7 is a graphical representation 70 of simulated antenna efficiency for the dual band antenna of FIG. 5, with the magnitude expressed as a percentage (e.g. Energy Out/Energy In). It can be seen that there is a sharp increase in total efficiency around 2.4 GHz and a local maximum in total efficiency approaching 95% around 5.4 GHz.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments.

What is claimed is:

1. A dual band antenna, comprising:
a ground plane formed by a first conductive layer;
a first antenna element formed by the first conductive layer, the first antenna element is spaced from and electrically isolated from the ground plane, the first antenna element includes a first member forming a vertical portion of the first antenna element and a second member orthogonal to the vertical portion, the first antenna element is configured to resonate in a first frequency band that is centered at about 5.4 GHz; and
a second antenna element formed by the first conductive layer, the second antenna element is electrically connected to the ground plane and electromagnetically coupled to the first antenna element, the second antenna element includes a third member that extends along a first path that extends from the ground plane to a fourth member, wherein the first path is at least substantially parallel with the first member of the first antenna element wherein the fourth member extends along a second path that is at least substantially parallel with the second member of the first antenna element and substantially orthogonal to the first path of the third member, and a fifth member connected with the fourth member and extending at least substantially parallel with the third member;
wherein the second antenna element extends at least partially around at least part of at least three sides of the second member of the first antenna element, the second antenna element is configured to resonate in a second frequency band that is centered at about 2.4 GHz.

2. The dual band antenna of claim 1, wherein the first conductive layer is a layer of a printed circuit board (PCB), such that first antenna element and the second antenna element are each on the PCB.

3. The dual band antenna of claim 2, wherein the first antenna elements and the second antenna element fit within a rectangular area of less than about 75 square millimeters on the PCB.

4. The dual band antenna of claim 2, wherein the first antenna elements and the second antenna element fit within a rectangular area of less than about 100 square millimeters on the PCB.

5. The dual band antenna of claim 2, wherein the PCB includes a second conductive layer and a dielectric layer separating the first conductive layer from the second conductive layer, wherein a via connects the first conductive layer to the second conductive layer through the dielectric layer.

6. An assembly comprising a dual band antenna on a PCB as recited in claim 5, and an electrical device coupled to the second conductive layer.

7. An assembly as in claim 6, wherein the electrical device is an impedance matching circuit.

8. An assembly as in claim 6, wherein the electrical device is a filtering circuit.

9. An assembly as in claim 6, wherein the electrical device is an amplification circuit.

10. The dual band antenna of claim 1, wherein the first antenna element is T-shaped.

11. A printed circuit board comprising:
a first conductive layer;
a second conductive layer; and
a dielectric separating the first conductive layer from the second conductive layer, with a via through the dielectric to electrically connect the first conductive layer to the second conductive layer; wherein:
the first conductive layer forms a ground plane;
the first conductive layer also forms a first antenna element spaced from and electrically isolated from the ground plane, the first antenna element includes a first member forming a vertical portion of the first antenna element and a second member orthogonal to the vertical portion, the first antenna element is configured to resonate in a first frequency band that is centered at about 5.4 GHz; and
the first conductive layer also forms a second antenna element that is electrically connected to the ground plane and electromagnetically coupled to the first antenna element, the second antenna element includes a third member that extends along a first path that extends from the ground plane to a fourth member, the first path is at least substantially parallel with the first member of the first antenna element, the fourth member extends along a second path that is at least substantially parallel with the second member of the first antenna element and substantially orthogonal to the first path of the third member, and a fifth member connected with the fourth member and extending at least substantially parallel with the third member;
wherein the second antenna element extends at least partially around at least part of at least three sides of the second member of the first antenna element, the second antenna element is configured to resonate in a second frequency band that is centered at about 2.4 GHz.

12. The PCB of claim 11, wherein the first antenna elements and the second antenna element fit within a rectangular area of less than about 75 square millimeters on the PCB.

13. The PCB of claim 11, wherein the first antenna elements and the second antenna element fit within a rectangular area of less than about 100 square millimeters on the PCB.

14. The PCB of claim 11, further comprising an electrical device coupled to the second conductive layer.

15. The PCB of claim 14, wherein the electrical device is an impedance matching circuit.

16. The PCB of claim 14, wherein the electrical device is a filtering circuit.

17. The PCB of claim 14, wherein the electrical device is an amplification circuit.

18. The PCB of claim 14, wherein the second conductive layer and the electrical circuit form an impedance matching circuit together.

19. The PCB of claim 14, wherein a conductive path between the electrical device and a contact point of the dual band antenna is a transmission line having an impedance of about 50 ohms, and the dual band antenna has an impedance of about 50 ohms.

20. The PCB of claim 11 wherein the first antenna element is T-shaped.
